(19) United States
(12) Patent Application Publication
(10) Pub. No.: US 2010/0037177 A1
(43) Pub. Date: Feb. 11, 2010

(54) TOOL FOR CAPTURING DATA ACROSS WEB DOMAINS

(76) Inventor: Andre O. Golsorkhi, Philadelphia, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/188,363

(22) Filed: Aug. 8, 2008

(51) Int. Cl. G06F 3/048

(52) U.S. Cl. 715/818

(57) ABSTRACT

A method for assisting a user in reviewing items displayed on an internet host page includes providing at the user location a data capture toolbar having a server remote from the user location and remote from the host location, selecting an item to provide a selected item, and searching the host page by the data capture system to determine data associated with the selected item. The selected data is stored on the data capture toolbar and at the server. The selected item is stored by dragging and dropping a representation of the selected item from the host page to the data capture toolbar by the user. The method also includes navigating to a further host page, displaying a further plurality of items, and storing further selected data at the server. At least a portion of the further selected data is displayed on the data capture toolbar.

### BACKGROUND OF THE INVENTION

1. Field of Invention

This invention relates to the field of internet commerce and in particular collecting resources for internet commerce.

2. Description of Related Art

U.S. Pat. No. 6,693,652 issued to Barrus teaches a multimedia message system automatically generates visual representations (e.g. thumbnails) of message or media objects and references (e.g. links) between media objects, nests messages within themselves, and automatically updates generated thumbnails. An object, including a thumbnail image of the object's contents and a link to the original content, is created in response to simple user inputs or commands. An image of the object is generated whether the object is a web page, a multimedia message, a hypertext link, a video clip, or a document. A link or reference to the original object from which the image is formed is also generated. The system taught by Barrus retrieves and displays information referenced by an object and shown by the thumbnail image corresponding to the object. The Barrus system also automatically updates the thumbnail image(s) representing an object any time the underlying object or information from which the image it generated is been modified.

All references cited herein are incorporated herein by reference in their entireties.

### BRIEF SUMMARY OF THE INVENTION

A method for assisting a user at a user location in reviewing a plurality of items displayed on an internet host page located at a host location remote from the user location includes providing to the user a data capture toolbar on a display at the user location by a data capture system having a data capture and storage server remote from the user location and remote from the host location, navigating to the host page by the user, selecting an item of the plurality of items by the user to provide a selected item, and searching the host page by the data capture system to determine by the data capture system data associated with the selected item to provide selected data. The selected data is stored at the data capture and storage server by the data capture system to provide remotely stored selected data and at least a portion of the remotely stored selected data is stored on the data capture toolbar. The selected item is stored by dragging and dropping a representation of the selected item from a display of the host page to the data capture toolbar by the user. The method also includes navigating to a further host page, displaying a further plurality of items by the user, selecting a further item of the further plurality of items from the further host page by the user to provide a further selected item, and storing further selected data associated with the further selected item at the data capture and storage server to provide further remotely stored selected data. At least a portion of the further remotely stored selected data is displayed on the data capture toolbar.

The further host page is searched by the data capture system to determine by the data capture system further data associated with the further selected item to provide the further remotely stored selected data. The remotely stored selected data and the further remotely stored selected data are arranged by the data capture system to provide a comparison by the user. The comparison is provided while the user is visiting at least one of the host page and the further host page or after the user completes visiting at least one of the host page and the further host page. Revisiting the host page or the further host page by the user in accordance with link information associated with the host page or the further host page stored at the data capture and storage server is also recited. The data capture system is provided with a plurality of operational modes including a shop mode and a collect mode.

The selected data is a description of the selected item, a price of the item, a time stamp of the selecting of the selected data, or an image representative of the item. The image representative of the item is obtained by the data capture system from the host page or from a location remote from the host page. Images representative of at least two differing views of the item can be obtained. The remotely stored selected data is edited by the user. The editing of the remotely stored selected data by the user is performed independently of further access to the host page.

Address information of the host page is stored at the data capture and storage server. The remotely stored selected data and the address information are stored in accordance with a save operation performed by the user. The host page is searched by the data capture system in accordance with an event listener. The selected item is determined by the data capture system in accordance with a pattern recognition method. A comparison of selected items of the plurality of items of the host page is provided by the data capture system. Further information with respect to the selected item is provided by the data capture system from an information source remote from the host page independent of access to the information source by the user. The further information includes review information.

At least a portion of the remotely stored selected data is transmitted by the user to a further user. The at least a portion of the remotely stored selected data is transmitted by transmitting to the further user a link for linking the further user to the data capture and storage server. Advertising material is provided to the user. User behavior information is determined by the data capture system in accordance with user activity while using the data capture system. Advertising material is provided to the user in accordance with the determined behavior information. The behavior information is provided to a publisher. Communication between the user and the publisher is provided by way of the data capture toolbar. A plurality of items is collected by the user to provide an item list. The item list is a gift list. The gift list is a wedding registry. The item is a sale item, a video, an image or text.

FIG. 1 shows a diagram representation of the process that takes place when the user loads a remotely served web page in the browser with the toolbar invention installed as a browser extension or plug-in. FIG. 2 shows a diagram representation of the process that takes place when the user drags elements located within the boundaries of the host page by pressing their mouse button while over the element, moving the mouse so that the element moves with their mouse pointer around the page, and eventually releases the mouse button. Analysis of this behavior reveals to the toolbar invention what the user intends to do with the page element. The possible outcomes include saving the page element as an item to the server or returning it to its original location without consequence.

FIG. 3 shows a diagram representation detailing the process of capturing item data from the source internet web page when the item is saved to the server as shown in FIG. 2 step 216. A part of this process is to create an HTML form for the editing or confirmation of this data, which then saves those edits to the server using an HTTP request as detailed in FIG. 4. FIG. 4 shows a diagram representation detailing the process by which the toolbar invention creates an HTML form and places it on the page for editing item data. This is an exploded view of steps 310 & 311 in FIG. 3.

FIG. 5 shows a diagram representation of the process that takes place when the user drags elements located within the boundaries of the toolbar invention by pressing their mouse button while over the item, moving the mouse so that the item moves with their mouse pointer around the page, and eventually releases the mouse button. Analysis of this behavior reveals to the toolbar invention what the user intends to do with the toolbar item. The possible outcomes include removing the item from both the toolbar and the server, reordering the placement of the item within the toolbar, or returning it to its original location without consequence.

FIG. 6 shows a diagram representation of the process that takes place when the user presses and releases the mouse button without having moved it, and while the mouse pointer is positioned over an existing item in the toolbar. This action indicates to the toolbar invention that the user intends to reveal details of the item within the toolbar, along with options to perform various functions related to that item.

FIG. 7 shows a diagram representation of the process that takes place when the user elects to reveal items that exist within the active list, but are hidden due to there being too many to display within the space provided. The user releases a button indicating the direction of the desired items. The toolbar responds by visually moving the list in the opposite direction, in an animated fashion, so that the once visible items are now hidden and the hidden items are now visible.

FIG. 8 shows a diagram representation of the process that takes place when the user elects to change the currently active and visible list of items. FIG. 9 shows a diagram representation of the process that takes place when the user elects to create a new list of items.

FIG. 10 shows a diagram representation of the process that takes place when the user elects to invite a friend to view the details of the currently active item via automated email delivery containing a message and hyperlink to the item, or via another system of notification within the confines of the social networking community.

FIG. 11 shows a diagram representation of the process that takes place when the user positions the mouse pointer over one of the items visible in the currently active list within the toolbar. This behavior is interpreted by the toolbar as a request for a brief summary of information. That request is fulfilled by creating a floating HTML object containing such information and placing near the item until the mouse pointer is no longer positioned over the item.

FIG. 12 shows a diagram representation of the process that takes place when the user clicks on a button with the intention to switch among the operational modes of the toolbar. The toolbar can fetch data relating to the user's most recent activity regarding that mode through an HTTP request, which may include the last item list that user was interacting with in that mode. The toolbar can then output that list or any other relevant data by displaying the list data, or visual representation thereof, in the toolbar area.

FIG. 13 shows a diagram representation of the process that takes place when the toolbar retrieves third-party product information relating to the list item or items currently being displayed in the toolbar. The toolbar requests information using an HTTP request based on data already known about the item or items from the central server. That server employs APIs provided by third-party data aggregation services and returns any retrieved data to the toolbar. The toolbar then displays the product information in an area of the toolbar for the user to review.

FIG. 14 shows a drawing of a portion of the toolbar that illustrates the display of item details. With these details, buttons can be provided for further user interaction with the toolbar relating to that item.

FIG. 15 shows a drawing of a portion of the toolbar that illustrates the display of a list of items. With this list, buttons can be provided for the user to select a different operational mode of the toolbar. Also, and drop down list can be provided for the user to choose another list that may be relevant to the user.

FIG. 16 shows a drawing of a portion of the toolbar that illustrates the display of an area of the toolbar that can float above an item or element to provide more information about that item or element. This area can be made to appear and provide this information when the user positions the mouse pointer over an item or element.

FIG. 17 shows a drawing of a portion of the toolbar that illustrates the display of an area of the toolbar in which a form can be placed for the user to edit details relating to an item. This area may contain text input boxes, drop down selections, buttons or other HTML elements.

FIG. 18 shows a drawing a browser page that illustrates various host page elements that can be captured and the display of the toolbar on some area of the page. The drawing also illustrates the ability of the user to drag elements from the host page into the toolbar for capture.

FIG. 19 shows a drawing of a portion of the toolbar that illustrates the display of an area of the toolbar in which product data can be displayed that has been retrieved from third-party services.

FIG. 20 shows a drawing of a portion of the toolbar that illustrates the display of an area of the toolbar in which a form can be displayed for the user to select other internet users with which they would like to share information related to an item or list being displayed. The user can select users already known or connected to that user, or can add new users on an ad-hoc basis.

A utility is provided for methods of collection and customization of internet resources. The utility could take the form of an extension to existing web browser software wherein programming code would be added to an internet document that a user of that browser may have loaded. This code could build a toolbar on the web page by adding images, tables or other structural elements to that page. With the toolbar in place the user could drag elements that are a resource of the original, unaltered web page into the toolbar area, thus giving that user a visual simulation of the collection of that resource. The toolbar could search the web page for relevant information about the resource, such as titles, descriptions, prices, and metadata. The toolbar could then communicate relevant data with a centralized server regarding the resource in question and the intentions of the user in order to save relevant data for that resource in a file or database linked to that user, and grouped with other items of data within the wishes of that user. The user can then reload that saved data into the toolbar, through a web portal for the service, or some other way for whatever purposes the user wishes, such as review of data, a pathway to return to the original, sharing data with friends through the utility, data comparison of commercial products, education and more.

### BRIEF DESCRIPTION OF SEVERAL VIEWS OF THE DRAWINGS

FIG. 1 details the process that takes place when the user loads a remotely served web page in a browser with the toolbar installed.

FIG. 2 shows the use of the data capturing tool of FIG. 1 when a user drags an element located in the host page.

FIG. 3 shows the toolbar's process of capturing data related to the element dragged in FIG. 2.

FIG. 4 shows how the toolbar provides an HTML form for editing item data, as an exploded view of steps 310 & 311 in FIG. 3.

FIG. 5 shows the result of the user dragging items that are located in the toolbar already.

FIG. 6 shows the result of the user clicking on an item in the toolbar, and further when a user clicks on a button thus revealed.

FIG. 7 shows the process of scrolling among pages of items in the toolbar.

FIG. 8 shows the process that takes place when a user elects to change the visible list of items.

FIG. 9 shows the process that takes place when the user elects to create a new list of items.

FIG. 10 shows the process of a user sharing an item with a friend using the toolbar's sharing functionality, having clicked the share button in FIG. 6.

FIG. 11 shows the toolbar providing more information about an item by floating an HTML bubble near the relevant item.

FIG. 12 shows the process of switching among operational modes of the toolbar.

FIG. 13 shows the process of fetching and outputting third party data comparison data for the selected item.

FIG. 14 is a drawing of the item details area.

FIG. 15 is a drawing of the item list area displaying a selected list.

FIG. 16 is a drawing of the item list area with a pop-up informational bubble showing for an item in the list.

FIG. 17 is a drawing of the item details area with the area above it for editing the item's details.

FIG. 18 is a drawing of a webpage loaded, the toolbar visible within it, and element of the page being dragged into the toolbar.

FIG. 19 is a drawing of retrieved item information being displayed for the user.

FIG. 20 is a drawing of a form for the sharing of item or list data among users.

### DETAILED DESCRIPTION OF PREFERRED EMBODIMENTS OF THE INVENTION

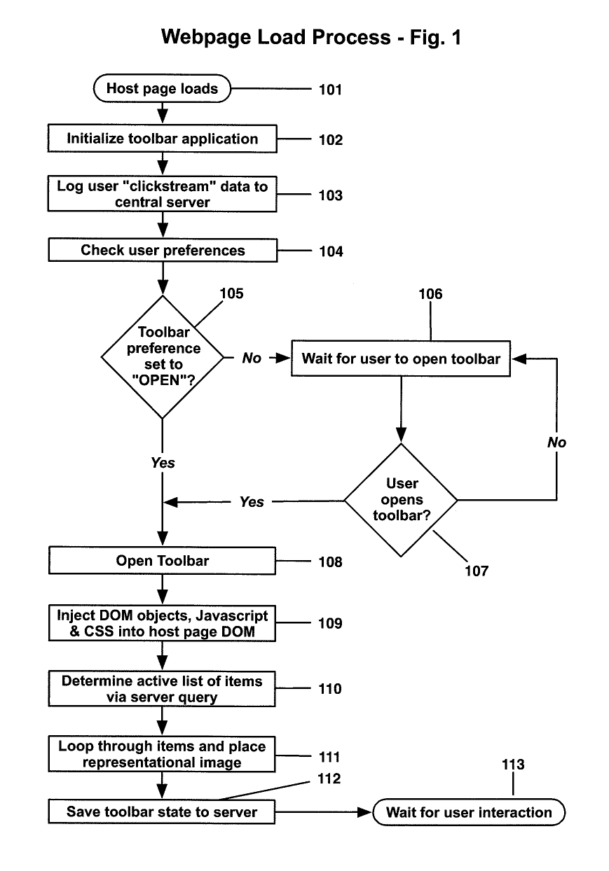

As represented in FIG. 1, herein relates to the process that takes place as the user of the web browser (1801) loads a remotely served internet document, hereafter referred to as the host page, by their own request, and having had at some point installed the toolbar invention described by this filing. Once the requested page has loaded to the point that the browser is aware of the structure of the Document Object Model (101), the toolbar can execute code to initialize itself (102) and synchronize its variables and functions with the host page. As the visitation to the host page by the user constitutes a chain-link in their browsing behavior, hereafter referred to as click stream data, the toolbar can save this data (103) to the centralized server using an HTTP request. The toolbar can check the user's saved preferences (104) to determine whether (105) the last state of the toolbar was open. If the toolbar is not set to open, there is no action to take (106) until the user elects to open the toolbar by buttons or contextual menus in the browser application.

If the toolbar is set to open (105) within the user's saved preferences, or if the user elects (107) to open the toolbar through some means such as described above, the following process (108) can take place. The toolbar (1803) can be created from a prescribed template, being made into HTML DOM elements, and can be injected (109) using JavaScript, or some other scripting language, into the host page along with any local or remote cascading style sheets required to display it properly. The currently active list of items can be retrieved (110) from the server using an HTTP request, and the toolbar can loop (111) through the items in the list, displaying them in the toolbar. The toolbar can save (112) its state to the server using an HTTP request so that further iterations may be generated in that state. The toolbar can sit (113) dormant on the host page until some user interaction takes place.

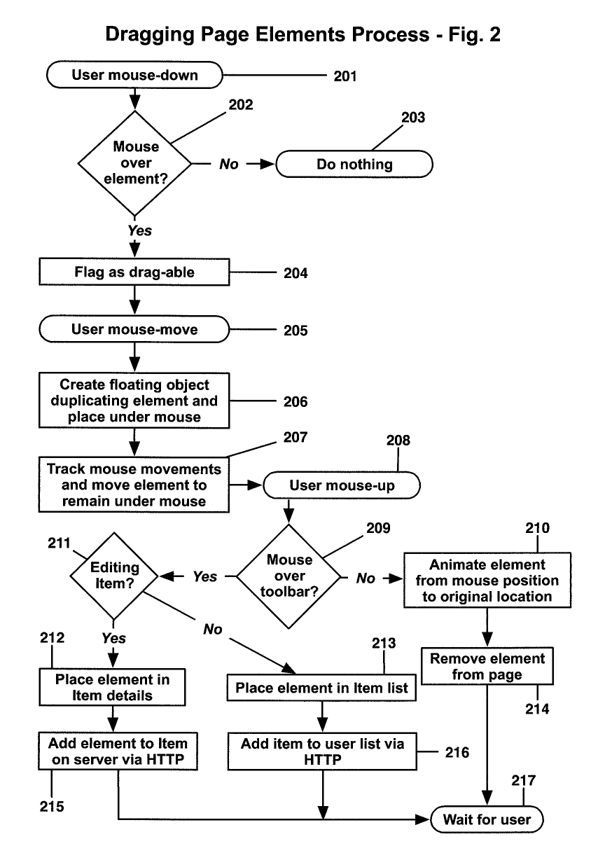

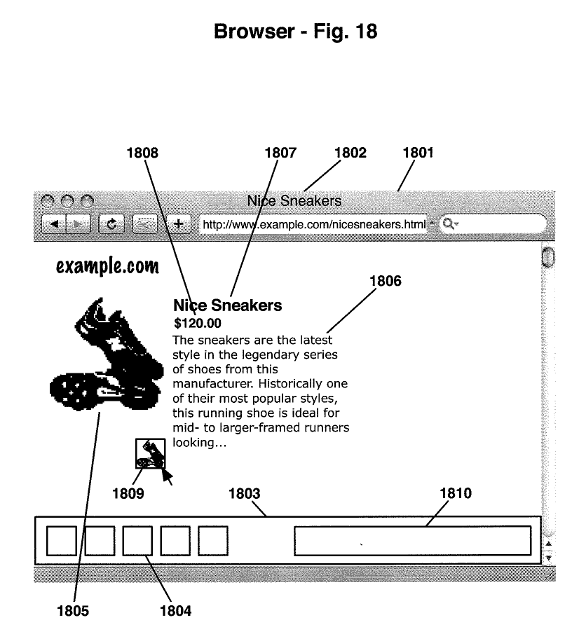

Represented in FIG. 2 is the process of dragging and dropping DOM elements generated by the host page into which the toolbar has been injected as drawn in FIG. 18. This process involves the software monitoring the user's mouse behavior on the host page using “event listeners” that can trigger functions in the software when the user presses, releases, clicks, or moves the mouse while the relevant browser window is active. When the user presses the mouse button (201) the toolbar can determine (202) if the mouse pointer has been positioned over a page element (1805) that can be dragged. If the element is not drag-able, the toolbar does nothing (203) and waits for further interaction, otherwise the software can flag (204) the element as drag-able and waits. When the user begins to move (205) the mouse in any direction the toolbar can create (206) a new HTML object (1809) that duplicates the aforementioned element, albeit sized within a specified range of height and width, and places it under the mouse pointer. As the mouse pointer continues to move, the new object can be moved (207) along the X and Y axis so that it remains under the mouse pointer.

When the user releases (208) the mouse button the toolbar can determine (209) if the mouse XY position is within the boundaries, or over the toolbar (1803). In the case that the mouse pointer is not over the toolbar, the object can be moved (210) back to its original location in an animated fashion, removed (214) from the host page, and the toolbar can sit (217) dormant awaiting further user interaction. In the case that the mouse pointer is over the toolbar, the assumption can be made that the user is attempting to capture that element. If the toolbar is currently in the state of editing an item (211), the assumption may be that the user wishes to add a new element to an existing item, and the element can be added (212) as an attribute of the item, being visually represented by a thumbnail image in the item details area (1810) of the toolbar. The toolbar then can add (215) the element to the item data using an HTTP request. If the toolbar is not in the state of editing an item, the assumption can be made that the user wishes to create a new item using the element being captured. The element can be placed (213) in the currently active item list (1 804), visually represented by a thumbnail image in the item list area of the toolbar. The item can then be created and added (216) to the server using an HTTP request. The toolbar can sit dormant after this awaiting further user interaction (217).

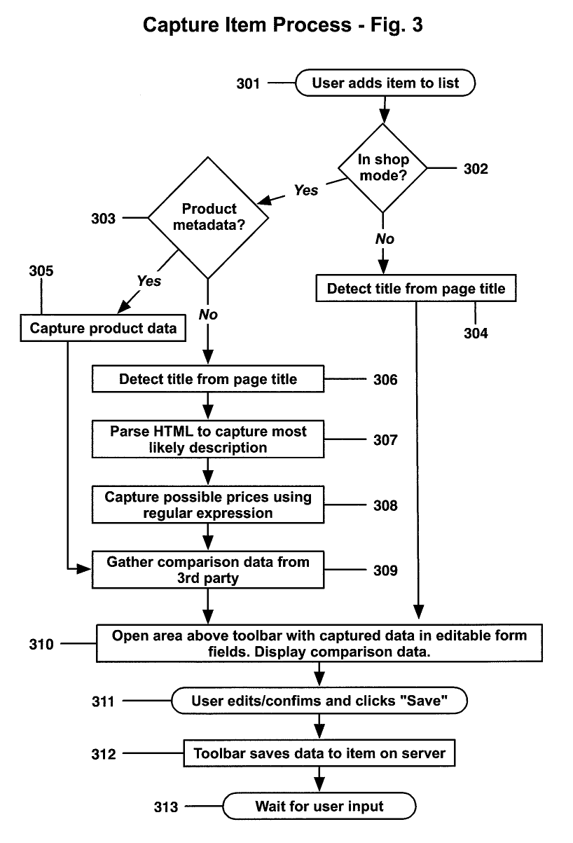

Represented in FIG. 3 is the process that can take place once the user has added an item to the toolbar as described above. This can be considered an exploded view of step 216 of FIG. 2. Once the user adds (301) the item to the list, it can be determined (302) whether the toolbar is in the operational mode set aside for the activity of “shopping.” When in shop mode, the toolbar may attempt to capture far more data than when it is in any other operational mode. The toolbar can search (303) the host page's DOM for metadata that has been predetermined to be reliable informational attributes of the item element being captured. As an example, if a website or group of websites is known to place an item's title and price in meta-tags with the ID of “productTitle” and “productPrice” respectively, the toolbar could capture this data without further investigation because it is known to be reliable. If this metadata is present the toolbar will capture (305) that data, but otherwise can attempt to find item attributes within the DOM of the host page. Typically, the item title can be captured (306) from the page title (1802), as most retailers use the title to display the product title for Search Engine Optimization. The HTML is searched (307) for blocks of text that may qualify as an item description by predetermined parameters, such as finding the longest text node on the page (1806) without visually dividing HTML tags (DIV, TR, TD). Prices (1808) can detected (308) by using a simple pattern matching algorithm such as a regular expression to create an array of all possible prices on the page, ordering them as choices based on their proximity to the captured page element. If the toolbar is not in shop mode, the new item's title can be captured from the host page title.

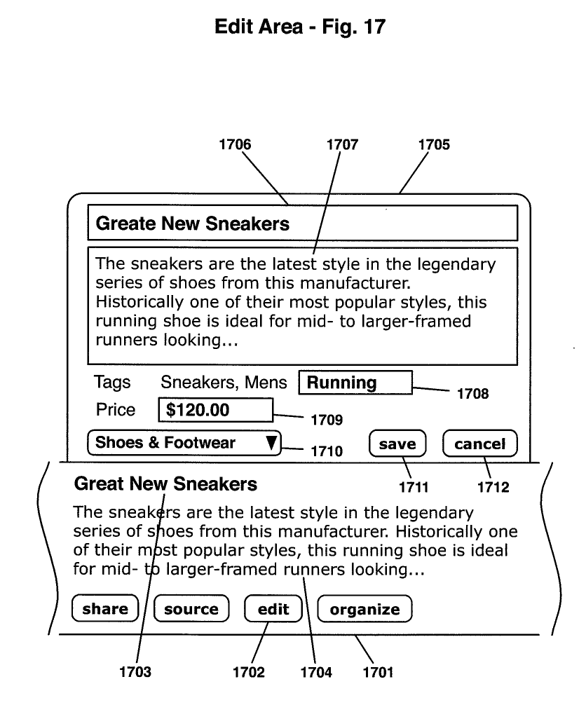

Once the item's attributes have been captured from the host page, the toolbar can request (309) third-party product comparison information from the server using an HTTP request. The server can make the request for that data using third-party data comparison engines' APIs. With this data, and the captured item attributes now known, the toolbar can create (310) an area (1705) containing an HTML form for the editing of the item attributes as drawn in FIG. 17. The user then may edit (311) or confirm the item's attributes (1706, 1707, 1708, 1709, 1710), and may click a “Save” button (171 1), at which time the item's attributes can be saved (312) using an HTTP request. The toolbar then can remove the area containing the item attributes form, by moving it out of sight in an animated fashion or by other means, and can wait (313) for further user interaction.

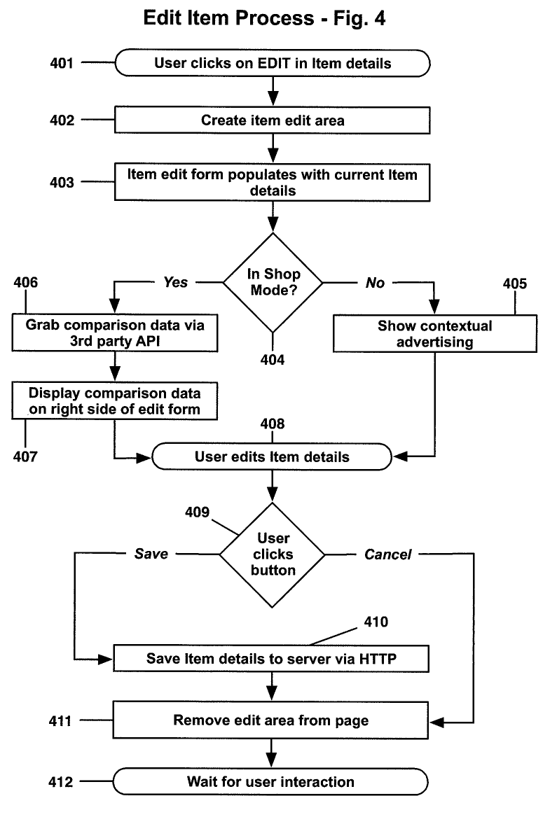

Represented in FIG. 4 is the process of editing an item's attributes within the toolbar by creating an area in which an HTML form is contained as drawn in FIG. 17. The user may initiate this process by clicking (401) the edit button (1702). The toolbar (1701) can respond by requesting item data from the server using an HTTP request. When that request is fulfilled, the toolbar can create (402) a new host page object (1705) with an HTML form containing (403) the current item attributes (1706, 1707, 1708, 1709, and 1710). This drawer-like object can be revealed by moving it up the page from behind the toolbar in an animated fashion. If the toolbar is currently in shop mode (404), it may request (406) third-party data comparison data for the item from the server using an HTTP request. When this comparison data is returned from the server it can be displayed (407) within the area next to the item details form. Contextual advertising may be shown (405) in place of, or along-side the third-party data comparison. The user may edit (408) item details, which can include simply reviewing the existing data without making changes, and can click (409) either the “Save” (1711) or “Cancel” (1712) buttons. When the user clicks the “save” button the item details can be saved (410) to the server using an HTTP request. Once the item's details are saved, or if the user had clicked “Cancel” instead of “Save,” the area can be removed (411) by moving down and out of view in the reverse of the animated process described for its opening or by other means. Once the area is removed the toolbar can sit (412) dormant waiting for user interaction.

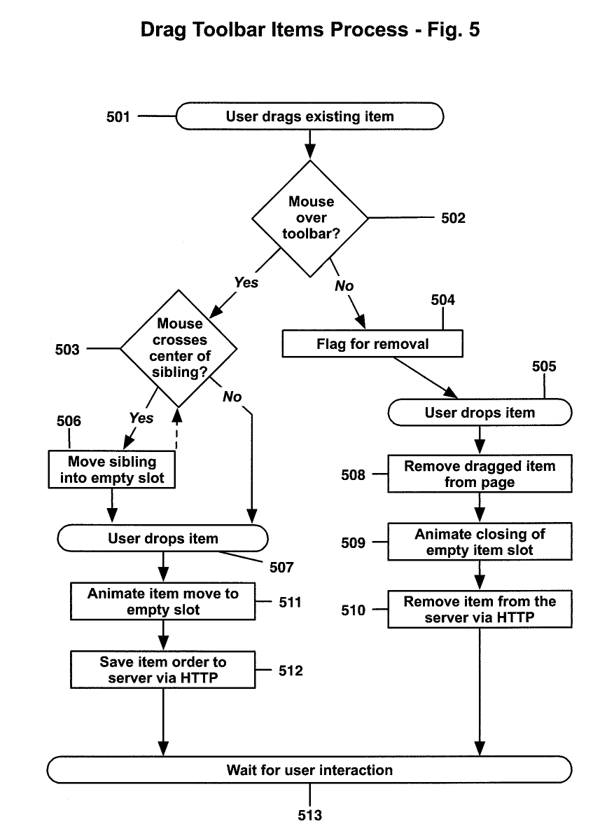

Represented in FIG. 5 is the process of dragging items within the toolbar. The user may press the mouse button and move (501) the mouse pointer while it is positioned over an item to drag the item. The thumbnail representation of the item can be removed from its place in the list and may become a free floating object. It may be constantly repositioned to stay under the mouse pointer as the user moves it. As the mouse pointer moves around the page, the toolbar can determine (502) the user's intentions based on whether the pointer is positioned over the toolbar or over the host page. If the mouse pointer is positioned over the host page, and not over the toolbar, a flag can be set (504) that the user intends to remove the item. When the user releases (505) the mouse, the item can be visually removed (508) from the host page, the slot it occupied in the list can be closed (509) by sliding the remaining items in the appropriate direction so that the next item occupies the empty slot, the toolbar can remove (510) the item from the server using an HTTP request, and can wait (513) for user interaction.

If the mouse pointer remains over the toolbar while dragging the item, the toolbar may determine that the user wishes to reorder the items within the list. In the case that the mouse pointer passes (503) over the middle (can be 50% of width) of a neighboring item, that item's position can be visually swapped (506) with the empty slot that is reserved for the dragged item. For example, if user is dragging the fourth item in the list and crosses the middle of the third item, then the third item moves one space to the right and the fourth item moves one slot to the left. When the user releases (507) the mouse button the item visually returns (511) to the empty slot which has been kept reserved for it. The toolbar can save (512) the order of the items to the server using an HTTP request, and wait (513) for further user interaction.

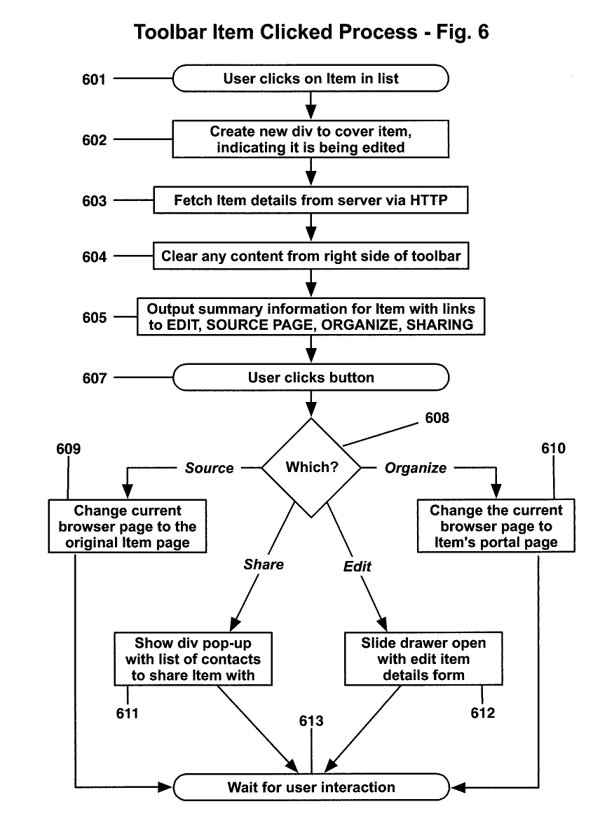

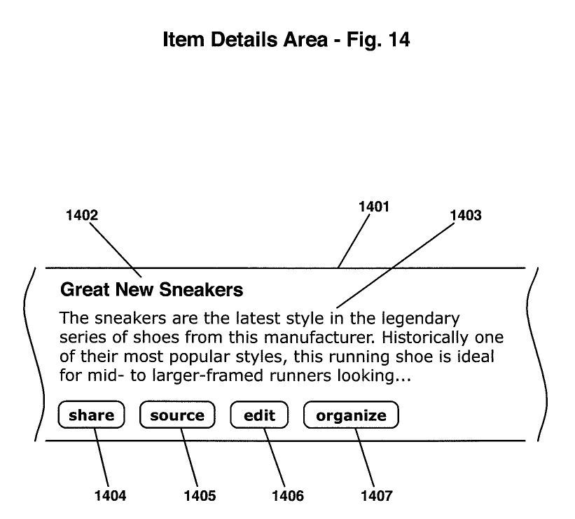

Represented in FIG. 6 is the process that can take place when the user clicks on one of the items contained in a list in the toolbar. When the user presses and releases the mouse button (601) while the pointer is positioned over an item in a list, the toolbar may interpret the user's behavior as an intention to have the item's details displayed in the toolbar. The toolbar can create (602) a new HTML object with the same dimensions as the clicked item, which can be positioned on top of the item with a low opacity setting to indicate that this item has been selected for viewing or editing. The toolbar can request (603) the item's attributes from the server using an HTTP request, clear (604) the right side of the toolbar (1401) of any content, and print (605) the requested item's attributes (1402, 1403) in that area along with buttons to further interact with item as drawn in FIG. 14. The user may click (607) on any of the following buttons with the outcome dependent (608) on which is clicked. If the user clicks (609) the “Source” button (1405) the host page can be changed to the original internet page from which the item was captured. If the user clicks (610) the “Organize” button (1407) the browser page can be changed to the internet page on the server's user portal correlating to the item. If the user clicks (611) the “Share” button (1404) the toolbar can create a new floating HTML object and place it near the current position of the mouse pointer. This object may contain a listing of the user's contacts within the community associated with the invention which can be selected for sharing. The user can elect to add email addresses on and ad hoc basis to this listing. Once the contacts have been selected or added, the user can click to share the item which may trigger the toolbar to communicate with the server using an HTTP request, which then may send emails or other communication to those parties with internet linkages back to this item for their review. If the user clicks (612) the “Edit” button (1406) the browser can create a new HTML object which may slide into view from behind the toolbar, and which contains an HTML form for the editing of the attributes associated with the selected item. After the actions take place due to interacting with any of these four buttons, or if the user hadn't clicked any of the buttons, the toolbar can sit (613) dormant awaiting further user interaction.

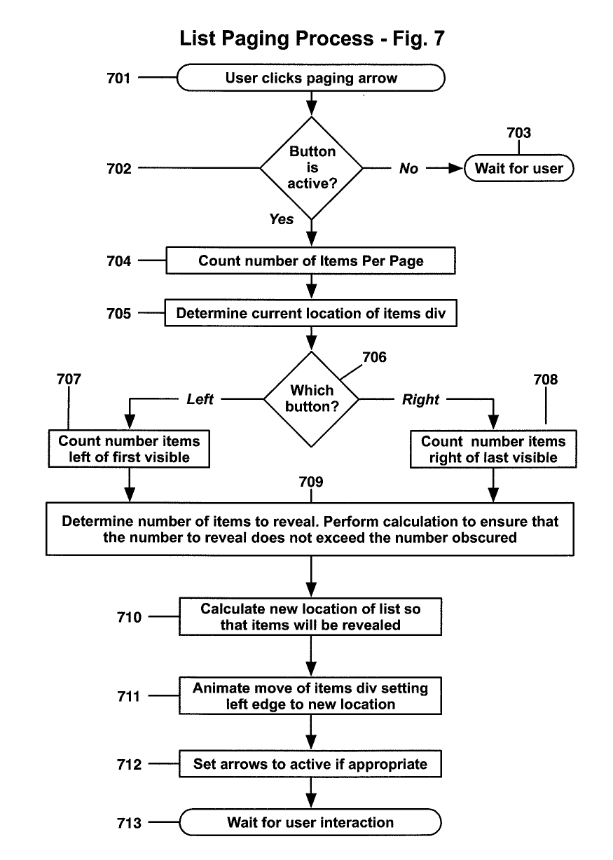

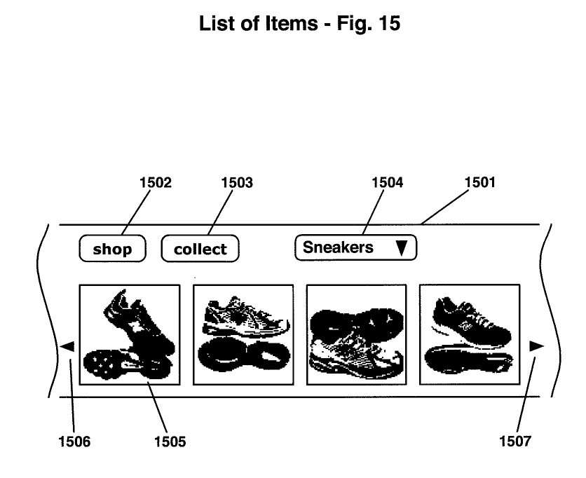

Represented in FIG. 7 is the procedure for paging left and right within the list of items currently being displayed as drawn in FIG. 15. The toolbar (1501) can display a fixed number of items (1505) dependent on the width of the active browser window. When there are more items contained in a list than can be displayed in that fixed space, a mechanism may be provided to the user for paging through the items, manifested by left and right directional arrow buttons (1506, 1507) around or near the list. When the user clicks (701) one of these buttons, the toolbar can confirm (702) that the button is active, e.g. that there are items to be revealed in relation to that button, and in the case that it is not active the toolbar may perform no action and wait (703) for the user to interact. Assuming the button is active, the toolbar can determine (704) the number of items to be displayed per page, determine (705) the current location of the list of items, and determine (706) which button was clicked. The toolbar counts (707, 708) the number of items out of view in the direction of the clicked button. If (709, 710) the number of items out of view is greater than or equal to the number of items per page, the number of items to reveal will be equal to the number of items per page. If the number of items out of view is less than the number of items per page, the number of items to reveal will be equal to the number of items out of view only so that the item list is not moved unnecessarily far. The actual paging may occur by moving the list of items the required number of pixels in the opposite direction of the button clicked in order to reveal items which are in the direction of the button clicked. The new location (711, 712) of the (left edge of the) item list can be determined by adding to or subtracting from the list's current location (705) a number equal to the number of items to reveal multiplied by the item slot size in pixels, taking into account any padding or margins, as appropriate. At this point the item list can be moved (713) by setting the left edge of the list to the number determined in either 711 or 712, and doing so in an animated fashion. When the list has been moved the toolbar updates (714) the active status of the buttons to reflect the current location of the list. After this, the toolbar can sit (715) dormant awaiting user interaction.

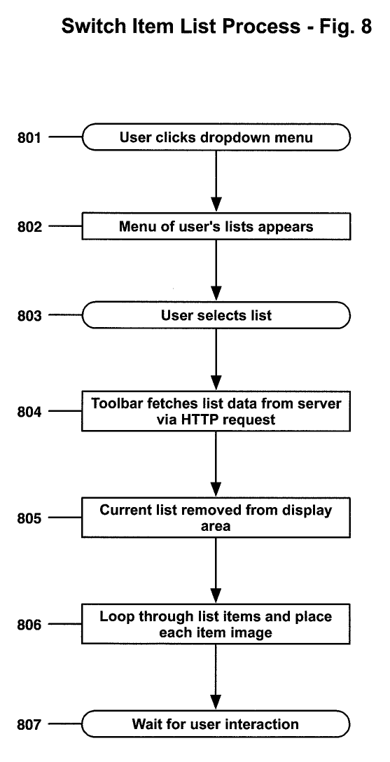

Represented in FIG. 8 is the process which can take place when the user elects to change the active list of items displayed as drawn in FIG. 15. In this scenario the user can click (801) the drop-down menu (1504) to display (802) the available item lists from which the user can choose. The user points the mouse (803) to the desired list and can click the mouse button to select it. The toolbar can request (804) all relevant information related to that list from the server using an HTTP request. The current list of items (1505) can be removed (805) from the toolbar by removing the HTML objects from the host page. The toolbar can loop (806) through the data returned by the server for the selected list, and create new HTML objects in which to place a thumbnail image representation of the item, and add that object to the area allocated to the list. When the list has been fully created, the toolbar can sit (807) dormant waiting for user further interaction.

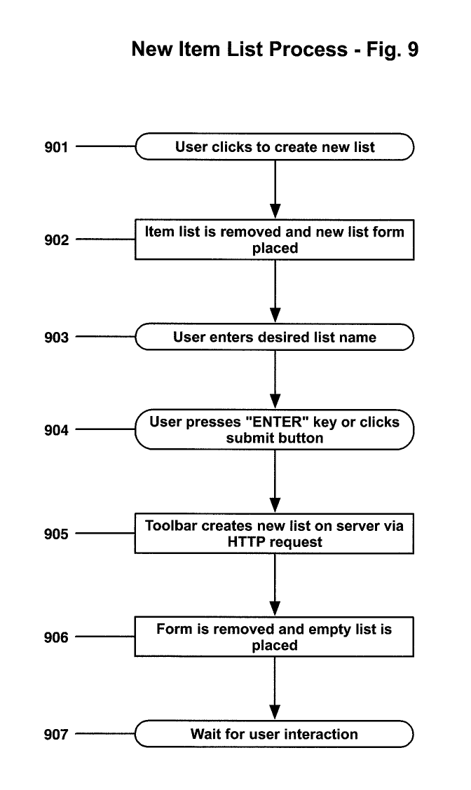

Represented in FIG. 9 is the process which can take place when the user elects to create a new list of items. The user can click (901) a button indicating the desire to create a new list. The current list of items can be removed (902) from the toolbar by removing the HTML objects from the host page, and an HTML form consisting of a text entry field can be created and put in its place. The user can type (903) the desired name for the new list and press (904) the “Enter” key on the keyboard or click the “Submit” button. The toolbar can create (905) the new list by request to the server using an HTTP request, and the form can be removed (906) from the item list area of the toolbar into which the new empty list can be created and placed (906). The toolbar can then sit (907) dormant awaiting further user interaction.

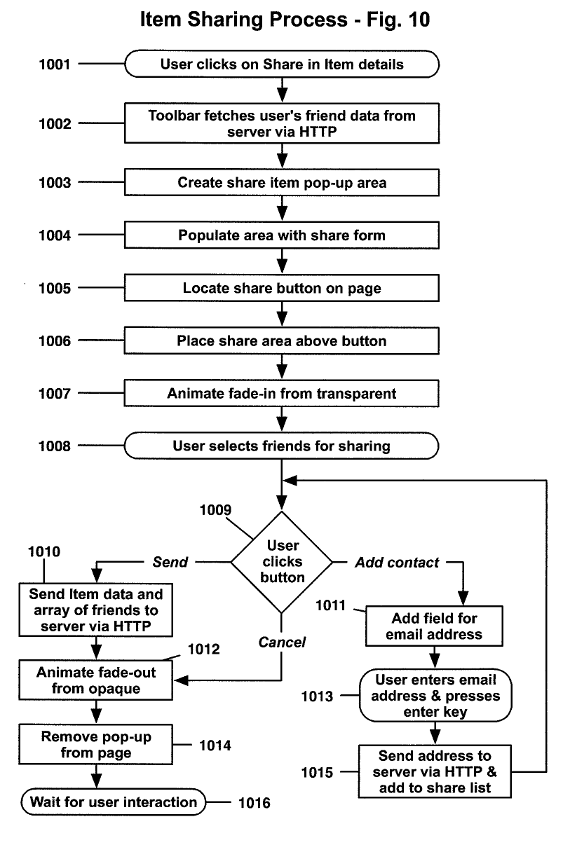

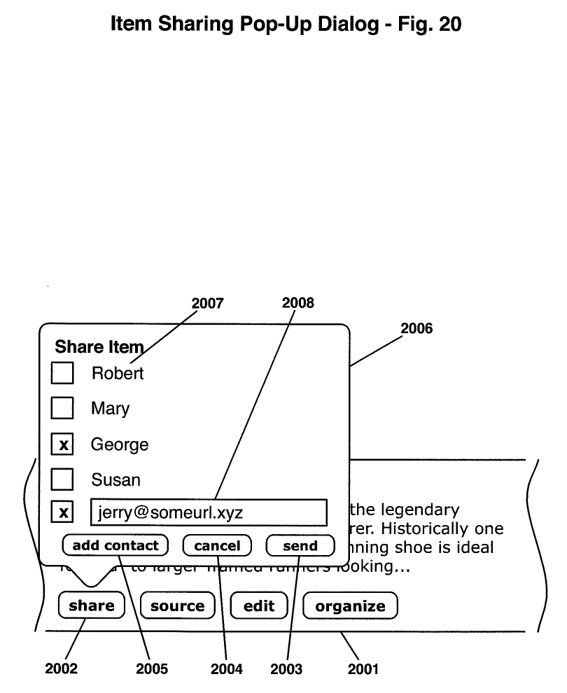

Represented in FIG. 10 is the process which can take place when the user elects to share an item with their contacts. This process is to be an exploded view of step 611 in FIG. 6. The user can start the interaction by clicking (1001) on the “Share” button (2002) while the active item's details are displayed on the right side of the toolbar (2001) as drawn in FIG. 20. The toolbar can then request (1002) data regarding the user's contacts from the server using an HTTP request. When that data is returned to the toolbar, a new floating HTML object (2006) can be created (1003) and placed into the host page, yet it is still may not be visible. A form can be created (1004) within that object containing a listing (2007) of the user's contacts from which the user can select with whom the user wishes to share this item. The toolbar can determine (1005) the location of the “share” button on the page and may place (1006) the new HTML object in close proximity to that button. When the object is correctly positioned, the toolbar can change (1007) the opacity of the object in an animated fashion, from transparent to opaque. At this point the user can select (1008) the contacts with which the user desires to share the item. It is also possible with this form to add a contact on an ad hoc basis, by entering an internet email address, with which the user can then share the item. The user can click (1009) one of three buttons (2003, 2004, 2005). If the user elects to add a new contact (2005), a text field (2008) can be created (1011) and displayed in the existing form into which the user enters (1013) an internet email address. That address can be saved (1015) to the server using an HTTP request and added to the listing of contacts in the form. When this part of the process completes the user returns to step 1009. The user may click the cancel button (2004), in which case the sharing form floating object can be removed (1014) from the page after making (1012) it transparent in an animated fashion and the toolbar can sit (1016) dormant awaiting user interaction. Finally, if the user selected contacts and clicks the “send” button (2003), the toolbar can request (1010) from the server that the current item be shared with the selected contacts using an HTTP request. The server can handle this request by alerting those contacts by email or other communication. When that request is fulfilled the sharing form floating object can be removed (1014) from the page after making (1012) it transparent in an animated fashion and the toolbar can sit (1016) dormant awaiting user interaction.

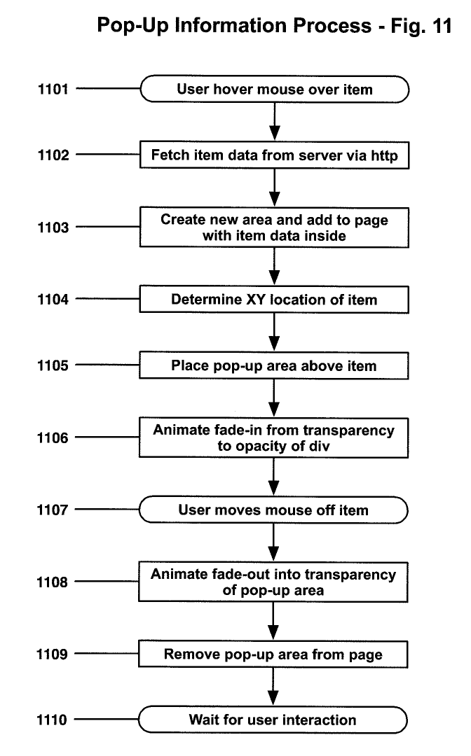

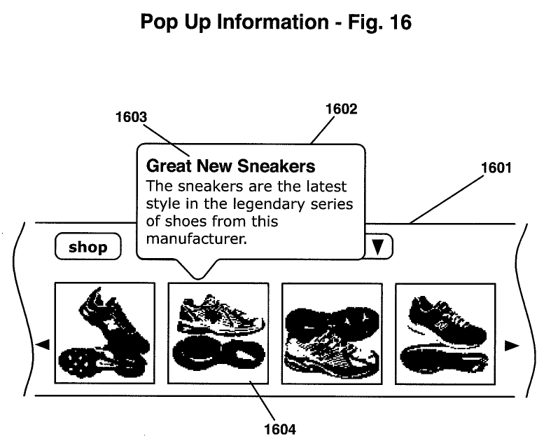

Represented in FIG. 11 is the process of the occurrence of a pop-up information bubble as drawn in FIG. 16. When the user moves (1101) the mouse so that it is positioned over an item (1604) in the toolbar (1601), and remains within those boundaries for a prescribed amount of time (˜0.5 sec), the toolbar can request (1102) item data from the server, such as title, description, price, etc using an HTTP request. Once the request has returned the item information, the toolbar can create (1103) a new floating HTML object (1602) and places it on the host page with its opacity set to zero. The content of the new object can be generated using the returned information, such as the relevant item's title and truncated description (1603). The toolbar can determine (1104) the location of the relevant item in pixels along the X and Y axes so that it may place (1105) the floating object in appropriate proximity to the item, indicating to the user that the information being provided refers to the item over which their mouse pointer is positioned. With the floating object correctly positioned over the relevant item, the toolbar can change (1106) the opacity of the object from transparent or 0%, to opaque or 100%, in an animated fashion. The object may remain in place until the user eventually moves (1107) the mouse pointer outside of the boundaries of the item, at which point the toolbar can change (1108) the opacity from 100% to 0% in an animated fashion. When the visibility of the object has been removed the toolbar can remove (1109) the object from the host page. The toolbar then can sit (1110) dormant, awaiting further user interaction.

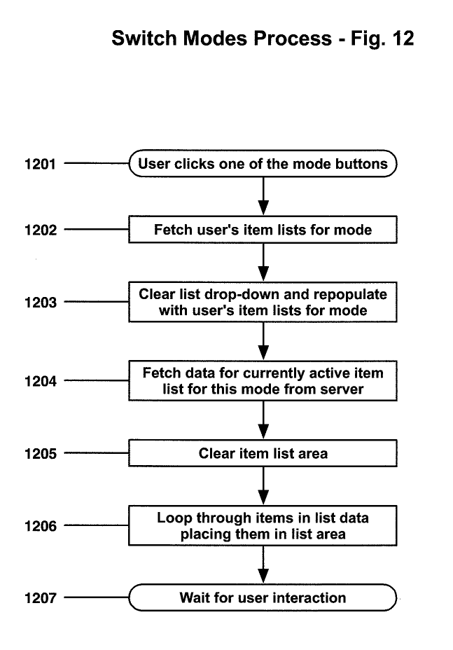

Represented in FIG. 12 is the process of switching from one mode to another within the toolbar. Upon the user's decision to switch modes, the user may click (1201) the corresponding mode's button (1502, 1503) as drawn in FIG. 15. Once a button is pressed the toolbar can request (1202, 1204) any available user data relating to the selected mode from the server, such as a listing of the user's item lists for that mode and the user's current active item list for that mode. Upon receiving the data, then the toolbar can clear (1203) the drop-down item list selector element (1504) of its choices so that it may loop through the returned lists to repopulate it. The toolbar also can clear (1205) the item list area (1505) so that it may loop (1206) through the items returned for the current item list for that mode and display thumbnail representations of each item. When this process is complete the toolbar can sit (1207) dormant, awaiting further user interaction.

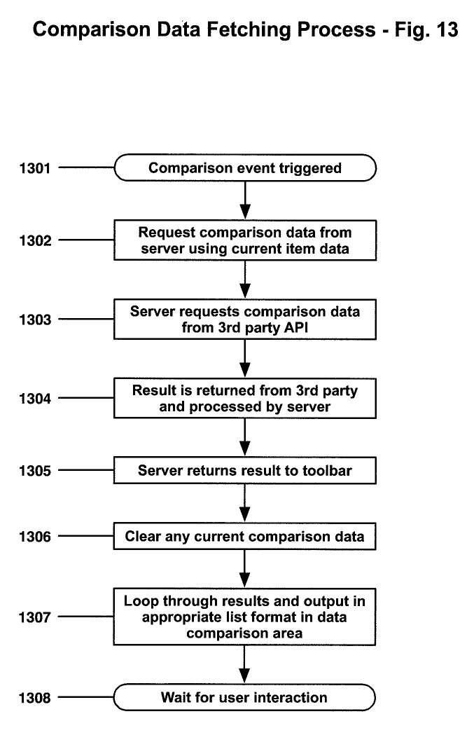

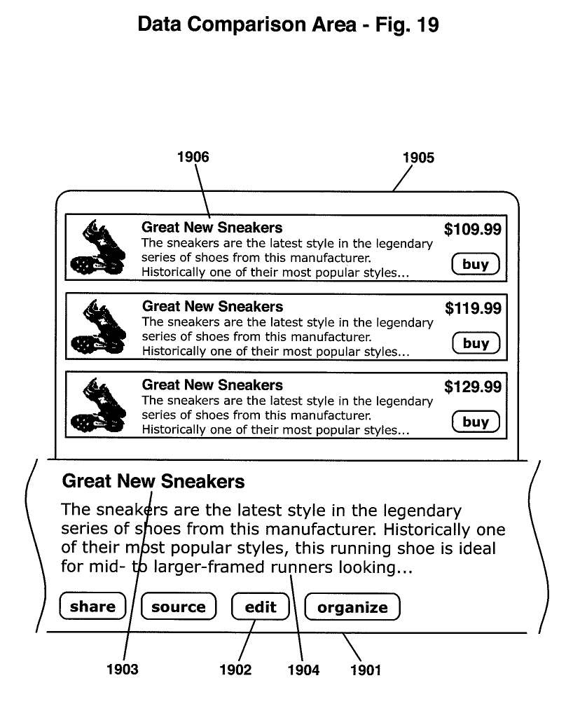

Represented in FIG. 13 and drawn in FIG. 19 is the process of fetching comparison data, relating to the visible item, from third party services and outputting that data within the toolbar. The nature of the data requested includes, but is not limited to, identical or similar products, and their prices, descriptions, photos and titles from various vendors. This process can be triggered (1301) by the user's request through clicking a data comparison button, or by another activity such as the event of capturing a new item from a web page element. When this process is triggered the toolbar requests (1302) the product comparison data, using the item's title (1903) or other item data as search criteria, from the server. The server requests (1303) the comparison data from third party services using an Application Programming Interface defined by that service provider. When the server receives (1304) the result, it can return (1305) the requested data to the toolbar. Upon receiving the data from the server the toolbar can clear (1306) the data comparison area. The toolbar may then loop (1307) through those results, outputting that data (1906) in the comparison area (1905) for the review of the user. When this process is complete the toolbar can sit (1308) dormant, awaiting further user interaction.

### Definitions

Toolbar—The software plug-in or extension based invention that this document describes. The document may refer to the toolbar as the HTML object on a web page that is created by the invention, or to the software code that creates it. For example we may say the toolbar (software) determines if the mouse pointer is positioned over the toolbar (HTML object).

User—The specific operator of the computer device with the invention installed as a plug-in or extension of their web browser.

Item—An internet resource such as an image, video, HTML snippet which, along with metadata-like attributes, has been virtually encapsulated into a new entity within the environment of the toolbar, or an accompanying internet website or sites. Each item may contain other internet resources, such as those mentioned above, as children or attributes of itself.

List—A user created grouping or collection of items.

Host Page—An internet web page resource that has been loaded into the user's browser application by the user's own choosing, having installed the invention as a plug-in or extension, and into which the toolbar is injected thus becoming a part of that page.

Over—The state of being within the left, right, bottom, and top edges, on the X and Y axes of an HTML object, and to be above something on the Z axis within the browser.

Server—The centralized internet HTTP server which communicates with all instances of the toolbar for all users. All data captured by users is stored in databases on this server.

Paging—Scrolling through or otherwise making visible items or other objects which otherwise would be out of the view of the user due to an excess volume of items or objects for the allocated space for viewing.

Animated—Moving, being moved or being changed in such a way that it takes place in a series of steps, or incremental movements, to appear as if there is motion or that a change is occurring during the passage of time.

Open—The state of the toolbar being visible and occupying space within the browser window.

Floating—The state of an HTML object which is placed above other HTML objects on the Z axis, and may be freely positioned about the page on the other axes as required.

Document Object Model—The hierarchical tagging model of an HTML web page that scripting languages can use to navigate through the structure of the document by reference to a tags parent, child or sibling.

Element—Any internet resource, such as images, movies or text that exists on the host page and is able to be captured by the user.

While the invention has been described in detail and with reference to specific examples thereof, it will be apparent to one skilled in the art that various changes and modifications can be made therein without departing from the spirit and scope thereof.

What is claimed is:

1. A method for assisting a user at a user location in reviewing a plurality of items displayed on an internet host page located at a host location remote from said user location, comprising:
(a) providing to said user a data capture toolbar on a display at said user location by a data capture system having a data capture and storage server remote from said user location and remote from said host location;
(b) navigating to said host page by said user;
(c) selecting an item of said plurality of items by said user to provide a selected item;
(d) searching said host page by said data capture system to determine by said data capture system data associated with said selected item to provide selected data;
(e) storing said selected data at said data capture and storage server by said data capture system to provide remotely stored selected data; and
(f) displaying at least a portion of said remotely stored selected data on said data capture toolbar.

2. The method for assisting a user at a user location in reviewing a plurality of items of claim 1, further comprising selecting said selected item by dragging and dropping a representation of said selected item from a display of said host page to said data capture toolbar by said user.

3. The method for assisting a user at a user location in reviewing a plurality of items of claim 2, further comprising:
(a) navigating to a further host page displaying a further plurality of items by said user;
(b) selecting a further item of said further plurality of items from said further host page by said user to provide a further selected item;
(c) storing further selected data associated with said further selected item at said data capture and storage server to provide further remotely stored selected data; and
(d) displaying at least a portion of said further remotely stored selected data on said data capture toolbar.

4. The method for assisting a user at a user location in reviewing a plurality of items of claim 3, further comprising searching said further host page by said data capture system to determine by said data capture system further data associated with said further selected item to provide said further remotely stored selected data.

5. The method for assisting a user at a user location in reviewing a plurality of items of claim 3, further comprising arranging said remotely stored selected data and said further remotely stored selected data by said data capture system to provide a comparison by said user.

6. The method for assisting a user at a user location in reviewing a plurality of items of claim 3, further comprising providing said comparison while said user is visiting at least one of said host page or said further host page.

7. The method for assisting a user at a user location in reviewing a plurality of items of claim 3, further comprising providing said comparison after said user completes visiting at least one of said host page or said further host page.

8. The method for assisting a user at a user location in reviewing a plurality of items of claim 3, further comprising revisiting said host page or said further host page by said user in accordance with link information associated with said host page or said further host page stored at said data capture and storage server.

9. The method for assisting a user at a user location in reviewing a plurality of items of claim 1, wherein said data capture system is provided with a plurality of operational modes.

10. The method for assisting a user at a user location in reviewing a plurality of items of claim 9, wherein said plurality of operational modes includes a shop mode.

11. The method for assisting a user at a user location in reviewing a plurality of items of claim 9, wherein said plurality of operational modes includes a collect mode.

12. The method for assisting a user at a user location in reviewing a plurality of items of claim 1, wherein said selected data comprises a description of said selected item.

13. The method for assisting a user at a user location in reviewing a plurality of items of claim 1, wherein said selected data comprises a price of said item.

14. The method for assisting a user at a user location in reviewing a plurality of items of claim 1, wherein said selected data comprises a time stamp of said selecting of said selected data.

15. The method for assisting a user at a user location in reviewing a plurality of items of claim 1, wherein said selected data comprises an image representative of said item.

16. The method for assisting a user at a user location in reviewing a plurality of items of claim 15, further comprising obtaining said image representative of said item by said data capture system from said host page.

17. The method for assisting a user at a user location in reviewing a plurality of items of claim 15, further comprising obtaining said image representative of said item by said data capture system from a location remote from said host page.

18. The method for assisting a user at a user location in reviewing a plurality of items of claim 15, further comprising obtaining images representative of at least two differing views of said item.

19. The method for assisting a user at a user location in reviewing a plurality of items of claim 1, further comprising editing said remotely stored selected data by said user.

20. The method for assisting a user at a user location in reviewing a plurality of items of claim 19, further comprising editing said remotely stored selected data by said user independently of further access to said host page.

21. The method for assisting a user at a user location in reviewing a plurality of items of claim 1, further comprising storing address information of said host page at said data capture and storage server.

22. The method for assisting a user at a user location in reviewing a plurality of items of claim 21, further comprising storing said remotely stored selected data and said address information in accordance with a save operation performed by said user.

23. The method for assisting a user at a user location in reviewing a plurality of items of claim 1, further comprising searching said host page by said data capture system in accordance with a user mouse click.

24. The method for assisting a user at a user location in reviewing a plurality of items of claim 1, further comprising determining said data associated with said selected item by said data capture system in accordance with a pattern recognition method.

25. The method for assisting a user at a user location in reviewing a plurality of items of claim 1, further comprising providing a comparison of selected items of said plurality of items of said host page by said data capture system.

26. The method for assisting a user at a user location in reviewing a plurality of items of claim 1, further comprising providing further information with respect to said selected item by said data capture system from an information source remote from said host page independent of access to said information source by said user.

27. The method for assisting a user at a user location in reviewing a plurality of items of claim 26, wherein said further information comprises review information.

28. The method for assisting a user at a user location in reviewing a plurality of items of claim 26, wherein said further information comprises comparison information.

29. The method for assisting a user at a user location in reviewing a plurality of items of claim 26, wherein said further information comprises research information.

30. The method for assisting a user at a user location in reviewing a plurality of items of claim 1, further comprising transmitting at least a portion of said remotely stored selected data by said user to a further user.

31. The method for assisting a user at a user location in reviewing a plurality of items of claim 30, further comprising transmitting said at least a portion of said remotely stored selected data by transmitting to said further user a link for linking said further user to said data capture and storage server.

32. The method for assisting a user at a user location in reviewing a plurality of items of claim 1, further comprising providing advertising material to said user.

33. The method for assisting a user at a user location in reviewing a plurality of items of claim 1, further comprising determining user behavior information by said data capture system in accordance with user activity while using said data capture system.

34. The method for assisting a user at a user location in reviewing a plurality of items of claim 33, further comprising providing advertising material to said user in accordance with said determined behavior information.

35. The method for assisting a user at a user location in reviewing a plurality of items of claim 33, further comprising providing said behavior information to a publisher.

36. The method for assisting a user at a user location in reviewing a plurality of items of claim 35, further comprising providing communication between said user and said publisher by way of said data capture toolbar.

37. The method for assisting a user at a user location in reviewing a plurality of items of claim 1, further comprising selecting a plurality of items by said user to provide an item list.

38. The method for assisting a user at a user location in reviewing a plurality of items of claim 37, further comprising using said item list to provide a gift list.

39. The method for assisting a user at a user location in reviewing a plurality of items of claim 38, wherein said gift list comprises a wedding registry.

40. The method for assisting a user at a user location in reviewing a plurality of items of claim 1, wherein said item comprises a sale item.

41. The method for assisting a user at a user location in reviewing a plurality of items of claim 1, wherein said item comprises a video.

42. The method for assisting a user at a user location in reviewing a plurality of items of claim 1, wherein said item comprises an image.

43. The method for assisting a user at a user location in reviewing a plurality of items of claim 1, wherein said item comprises text.
